(19) United States
(12) Patent Application Publication
(10) Pub. No.: US 2006/0218501 A1
(43) Pub. Date: Sep. 28, 2006

(54) Communicating objects between users or applications

(76) Inventors: Russell A. Wilson, Boca Raton, FL (US); Maria Milenkovic, Phoenix, AZ (US); Milan Milenkovic, Phoenix, AZ (US)

Correspondence Address: TROP PRUNER & HU, PC, 1616 S. VOSS ROAD, SUITE 750, HOUSTON, TX, 77057-2631, US

(21) Appl. No.: 11/441,765

(22) Filed: May 26, 2006

Related U.S. Application Data
(63) Continuation of application No. 09/641,431, filed on Aug. 18, 2000.
(60) Provisional application No. 60/213,318, filed on Jun. 22, 2000.

(51) Int. Cl. G06F 3/00

(52) U.S. Cl. 715/769

(57) ABSTRACT

Communications between users may be facilitated using a single window and a communications interface associated with that window. Transfers may be made by grabbing objects within the window and moving them to the communications interface. Icons may be associated with particular users and when objects are dragged-and-dropped to those icons, those objects may be automatically transferred to interfaces associated with those users.

This application is a continuation of U.S. patent application Ser. No. 09/641,431, filed on Aug. 18, 2000, which claims the benefit of U.S. provisional application No. 60/213,318, filed Jun. 22, 2000.

### BACKGROUND

This invention relates generally to user interfaces for processor-based systems.

A user interface enables a user to interact with a processor-based system such as a desktop computer, laptop computer, handheld computer, a set-top box, or a processor-based appliance. The user interface may include graphical objects such as windows that provide information about the various application programs operating on the processor-based system.

In Microsoft Windows® software, a variety of windows may be displayed on a given screen for each of a variety of applications. Communications between the windows may be accomplished by dragging-and-dropping objects between the windows. Each function that the user attempts to implement at the same time may be accomplished by creating yet another overlapping window display.

For some users, the proliferation of windows and the handling of those windows is a sufficiently daunting task to cause those users to avoid using processor-based systems. Moreover, in using windows interfaces, the actual operation that is occurring may not be immediately apparent to the user. Therefore, the user may not intuitively appreciate the operation that is occurring. As a result, the operation may be more difficult for the user to learn. The user may need to memorize the steps that must occur rather than simply doing those steps naturally based on an understanding of how the operation is implemented.

In the clipboard or cut and paste operation associated with Microsoft Windows® programs, the user can highlight text or graphics. The user then operates a copy button to “copy” the highlighted material. Thereafter, over a different window, the paste button may be operated to cause the previously highlighted information to be pasted into a document.

A problem with clipboard software is that when the user operates the copy or paste button, the user does not really get any intuitive feel for what happened to the highlighted material. Moreover, the user gets no visual representation of the material thereafter. The user must remember that the user has copied the material and then the user must remember to paste the material. Despite the graphically appealing nature of the Microsoft Windows® program, in some cases, the Windows® program lacks an entirely intuitive feel.

Thus, there is a need for better ways to communicate between computer users that avoids some of the complexity associated with existing applications and which has a more intuitive nature to facilitate the user's learning and understanding of the operation of communication tools.

### BRIEF DESCRIPTION OF THE DRAWINGS

FIG. 1 is a depiction of a graphical user interface in accordance with one embodiment of the present invention;

FIG. 2 is a depiction of the graphical user interface of FIG. 1 in the course of implementing an operation in accordance with one embodiment of the present invention;

FIG. 3 is a flow chart for software for implementing the operation shown in FIGS. 1 and 2;

FIG. 4 is a depiction of another graphical user interface in accordance with one embodiment of the present invention;

FIG. 5 is a depiction of the graphical user interface of FIG. 4 after a note has been posted in a user workspace;

FIG. 6 is a flow chart for the software which enables the transition between FIG. 4 and FIG. 5 in accordance with one embodiment of the present invention;

FIG. 7 is a depiction of still another graphical user interface in accordance with one embodiment of the present invention;

FIG. 8 is a flow chart for software for implementing the operation shown in FIG. 7 in accordance with one embodiment of the present invention;

FIG. 9 is a depiction of the graphical user interface in FIG. 1 in the course of another operation;

FIG. 10 is a depiction of the graphical user interface shown in FIG. 9 after completion of an operation;

FIG. 11 is a flow chart for software for implementing the operation shown in FIGS. 9 and 10; and

FIG. 12 is a block diagram of the hardware in accordance with one embodiment of the present invention.

### DETAILED DESCRIPTION

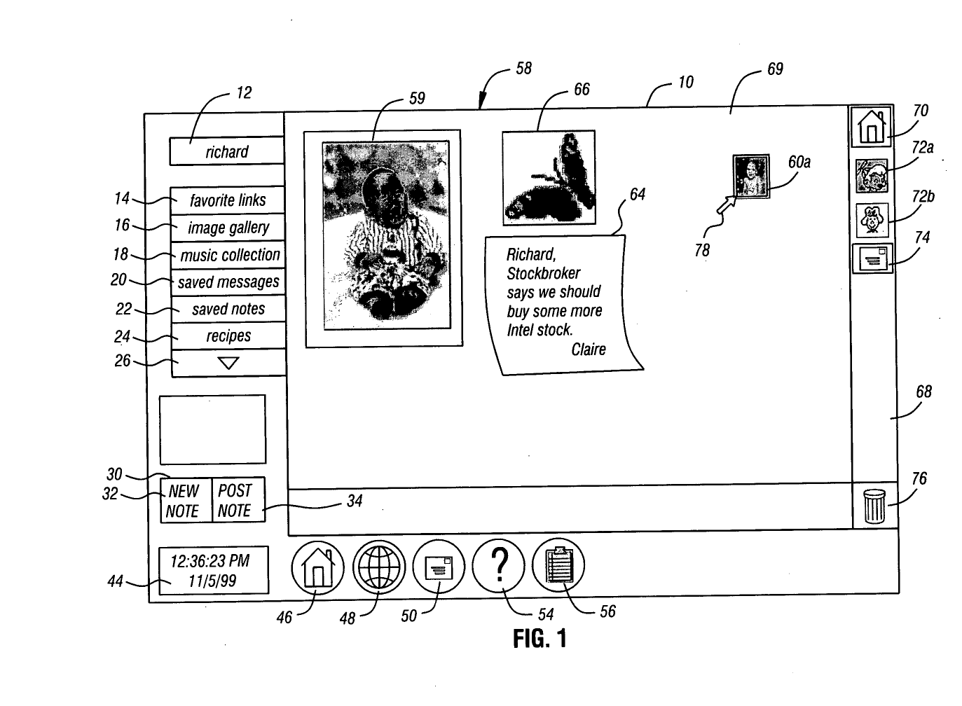

A user interface 10, shown in FIG. 1, for a processor-based system, such as a desktop computer, a laptop computer, a handheld computer, a processor-based appliance, or a set-top box, may be composed of a single window 58 together with a communications interface 68. The window 58 provides a user workspace 69 that includes areas for posting objects such as sticky note 64, digital image 59, or digital sound files (not shown). In the illustrated example, the interface 10 is associated with a particular user, named Richard, as indicated by the user interface component 12 illustrated as a button. Richard may have an animated icon 66 associated with Richard's interface 10.

Below the interface component 12, on the left side of the window 58, a plurality of interface components may be provided including a favorite links interface component 14. Each of the interface components 14 through 24 may be in the form of mouse selectable icon indicating the nature of a number of stored objects. In the case of the favorite links interface component 14, the stored objects may be Uniform Resource Locators for favorite Internet web pages. Those locators may be stored in a compact format accessible through the component 14. Once the component 14 is selected, the links may be displayed as a drop down display as one example.

Similarly, the interface component 16 may store a plurality of images. The interface component 18 may store a plurality of digital music files, the interface component 20 may store stored messages received by the user, the interface component 22 may store saved notes and the interface component 24 may store recipes. Additional interface components may be displayed by selecting the scroll down button 26.

In some embodiments of the present invention, the interface components 14 through 24 may be programmably determined. That is, the titling and the nature of the stored information may be programmably determined. In other cases, the titling and the nature of the material stored in each interface component 14 through 24 may be predetermined by the software provider.

A text entry block 30 enables the user to prepare notes. Whenever the user wishes to prepare a new note, the user may mouse select the new note button 32. When the user has completed the note, the user may mouse select the post note button 34 using the cursor 78 as indicated. In one embodiment of the present invention, sticky note style images are automatically created as indicated at 64. That is, the image 64 has the appearance of sticky note that has adhesive along the top edge and does not have adhesive on the bottom edge so that the image appears to curl up at the opposite edge.

The lower end of the window 58 may include a time and date display 44 and a plurality of function keys 46 through 56. The function key 46 transitions the display from an interface 10 associated with one particular user, in this case Richard, to a home interface shared by a plurality of users. The plurality of users may, in one embodiment of the present invention, be a family or other associated group of individuals who wish to use the same processor-based system and to communicate on that system with one another. However each user may be provided with his or her own interface 10 which may be accessed (as will be described hereinafter) through a password protection system.

The function key 48 enables immediate access to the Internet. A browser interface is selectively displayed within the workspace 69 in response to operation of the key 48. Similarly, the function key 50 provides an electronic mail interface and the function key 56 provides a notepad interface. Finally, the function key 54 provides user help with operating the various features described herein.

Each function key 46 to 56 corresponds to a different application having a different graphical user interface. When a new function key is selected a new application is executed and a new interface is displayed in the workspace 69.

The communications interface 68 may extend as a vertical strip along the right side of the window 58 in one embodiment of the invention. The interface 68 may include an iconless area 68a that acts as one user's personal communications interface. The iconless area 68a may be used to store representations of objects that the user wishes to temporarily store or subsequently transfer to either another user or another application. As used herein, objects may include textual or graphical files, audio or video files, script and application programs.

A plurality of icons 70, 72a, 72b act as iconized communication interfaces. Each of the icons 70, 72a and 72b corresponds to a user of a shared processor-based system in one embodiment. By clicking on an object and dragging-and-dropping it to the appropriate icon 70, 72a or 72b, the corresponding object is automatically transferred either to a home interface in the case of the icon 70 or to an interface associated with (and accessible by) another user in the case of icons 72a and 72b.

An icon 74 may correspond to a thumbnail representation of an object that a user has decided to store in the user's communications interface 68. The icon 74 may be stored in the interface 68 for an indeterminate amount of time. The user may use the storage space provided by the communications interface 68, for example, as a transfer point to transfer the corresponding objects to another application that may subsequently be displayed within the workspace 69.

In embodiments in which a “windowless” design is utilized, the communications interface 68 enables communications between application programs that are displayed within the workspace 69 at different times. In the case illustrated in FIG. 1, the icon 74 is a thumbnail depiction of an e-mail message that the user has prepared but not yet sent.

Incoming objects that have been received from other users may also be stored within the communications interface 68 before they are actually transferred into the user's workspace 69. In this way, the user decides whether to drag-and-drop the incoming objects, initially received in the communications interface 68, into the workspace 69 or, alternatively, to drag-and-drop them into the trash can interface 76 for disposal.

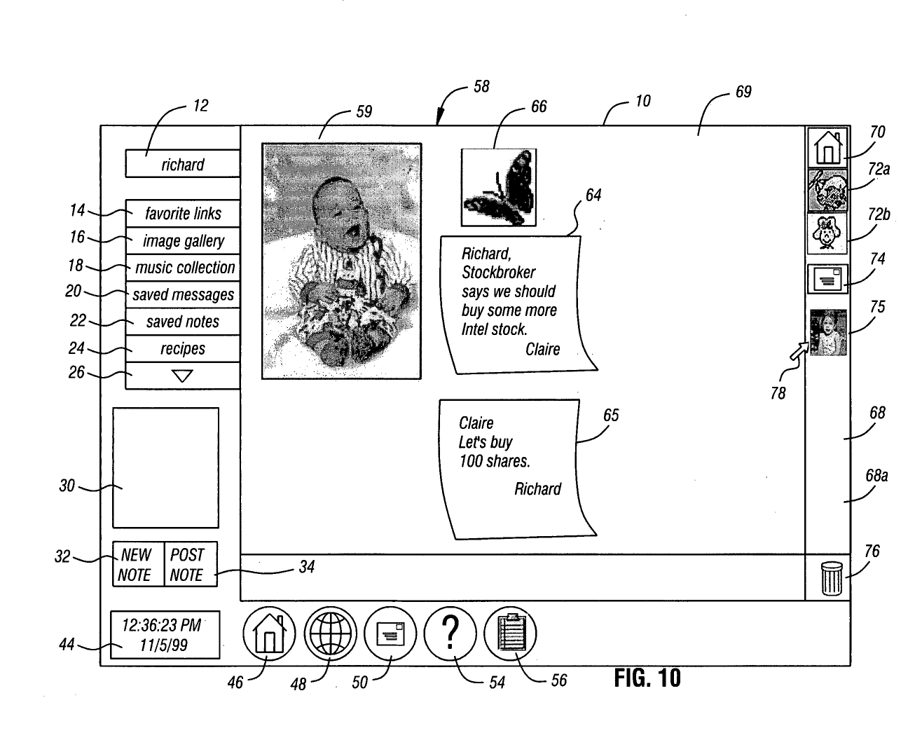

In FIG. 10, the user has positioned a cursor 78 over a digital image icon 75 in the communications interface 68. The icon 75 represents a digital image object. The user may then mouse click on the icon 75 causing the icon to attach to the cursor 78 as shown in FIG. 1. The user may transfer the digital image to another user's interface 10 via an icon 72 in the communications interface 68 or may drag-and-drop the icon into the workspace 69.

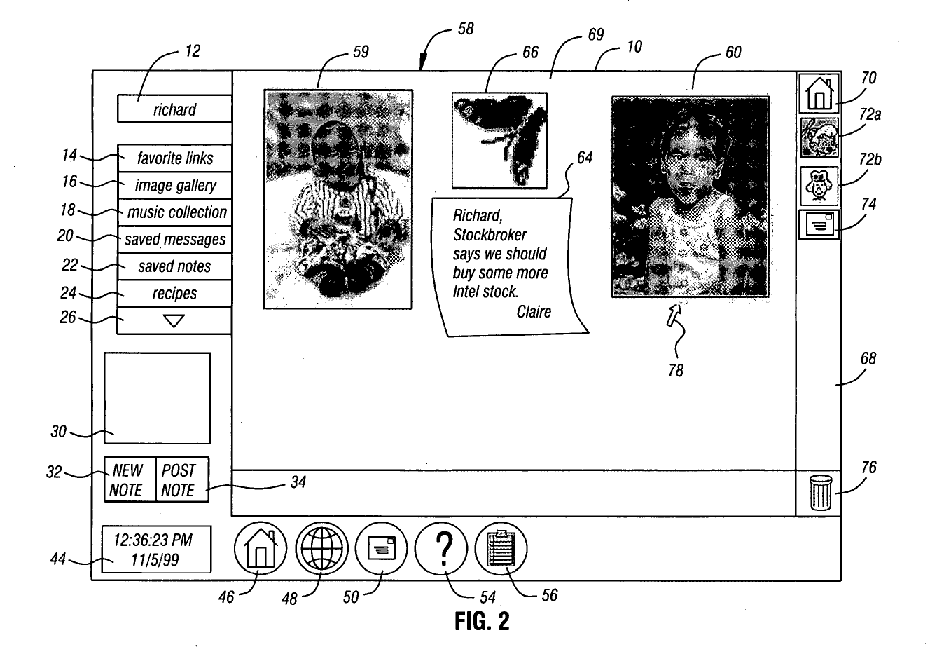

The thumbnail 60a, created when the icon 75 is clicked on, is moved with the cursor 78, as shown in FIG. 1, until it reaches its desired destination. When the user releases the mouse button, the thumbnail 60a assumes a full scale size image 60 and is displayed in the user's workspace 69 as shown in FIG. 2. Alternatively, the thumbnail 60a may be dragged-and-dropped to the trash can 76 wherein it is discarded.

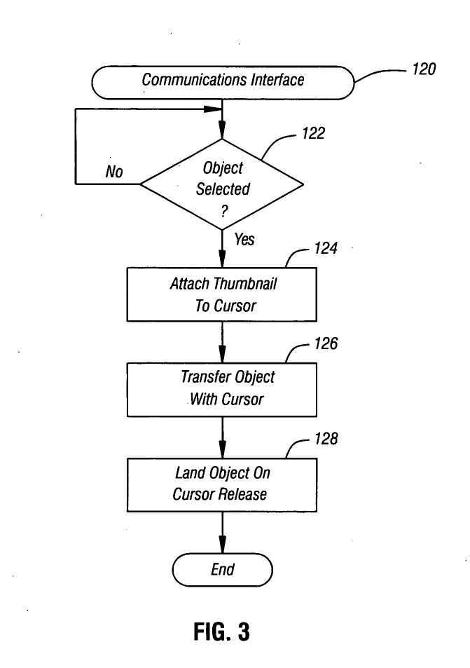

Referring next to FIG. 3, the communications interface software 120, in the embodiment of the invention, initially determines whether an object has been selected as indicated in diamond 122. The object may be selected by being mouse clicked on in accordance with one embodiment of the present invention. When an object has been selected, a thumbnail depiction of the object may be attached to a cursor as indicated in block 124. In one embodiment of the present invention, the thumbnail depiction may be semitransparent or transparent so that the underlying material can be readily viewed. This facilitates dragging-and-dropping the thumbnail at the desired location.

Referring to block 126, the object then moves with the cursor as the cursor moves. When the cursor reaches the desired location, the object is positioned at the location where the cursor is released as indicated in block 128.

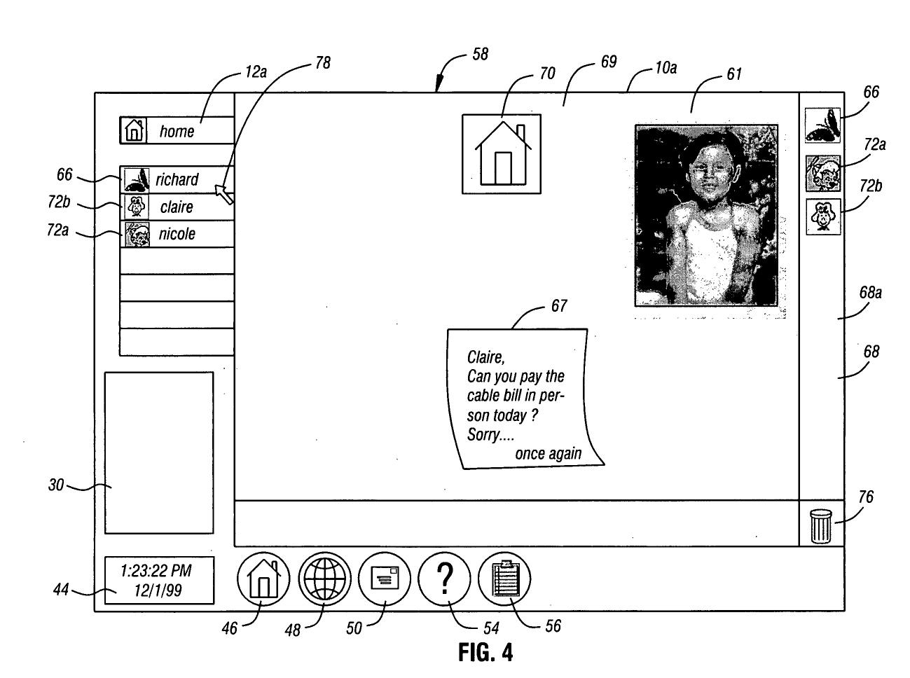

Turning now to FIG. 4, a home interface 10a for a group of users such as a family, a group of friends, a business organization, a social organization or the like may include a plurality of registered users. In the example illustrated in FIG. 4, the home interface component 12a is displayed above the icons for three family members including the father, Richard, indicated by the icon 66, the mother, Claire, indicated by the icon 72b and the daughter Nicole indicated by the icon 72a. In this case, the icon 70 for the home interface 10a is displayed within the window 58 and the icon 66 associated with Richard has now been moved over to the communications interface 68 where it is located adjacent the icons of the other users including the icon 72b for Claire and the icon 72a for Nicole.

A variety of objects may be posted on the home interface 10a such as a digital image 61 and a sticky note 67. The sticky note 67 may have been posted to the home interface 10a as a reminder by one user for all users to see. However, such a note may also be directed to only one of the users.

In one embodiment of the present invention, all sticky notes are communicated directly to the intended recipient and are likewise posted on the home interface 10a. In other cases, the publication of such notes on the home interface 10a may not be implemented automatically.

The home interface 10a functions like the front of a family refrigerator. A user may post various objects of interest on a refrigerator such as notes or pictures, using refrigerator magnets. The idea is that the refrigerator door is a public space used as a communications center by family members. Thus, the interface 10a effectively emulates the idea of a public posting place for all users of a processor-based system to see and to communicate with one another. To augment the refrigerator motif, magnet images (not shown) may be superimposed over the image 61.

Any user can bring up the home interface 10a. From the home interface 10a a user may access the user's private interface 10 by clicking on the appropriate one of the icons 66, 72d or 72b. Thus, when Richard clicks on the icon 66, the icon 70 is replaced with the icon 66 and vice versa and Richard's interface 10 is displayed in the window 58. Access to each individual user's interface 10 is password protected. Thus, when a user clicks on the user's icon, such as the icon 66, the user is asked for a password in order to access the corresponding user interface 10. Upon providing the password, a new interface 10 is displayed in the window 58. Thus, a group of users may each have their own private space as well as a public space in the form of the home interface 10a. Communications between any of the user's private interfaces 10 and the home interface 10a may be implemented using the communications interface 68.

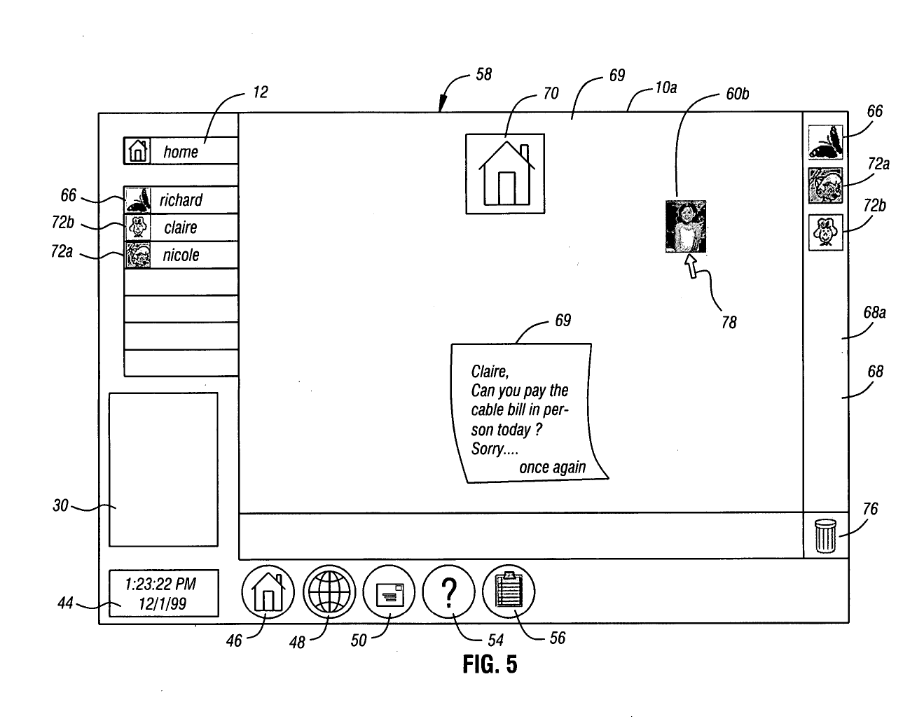

When a user mouse clicks on the image 61 (in FIG. 4) using the cursor 78, a thumbnail depiction of the image 61 is created as indicated at 60b in FIG. 5. This thumbnail depiction may be attached to the cursor 78 as indicated.

The cursor 78 may then be moved to a communications interface 68 icon associated with one of the other users. The mouse button may be released to transfer that object through the communications interface 68 directly to an interface associated with the icon-selected user.

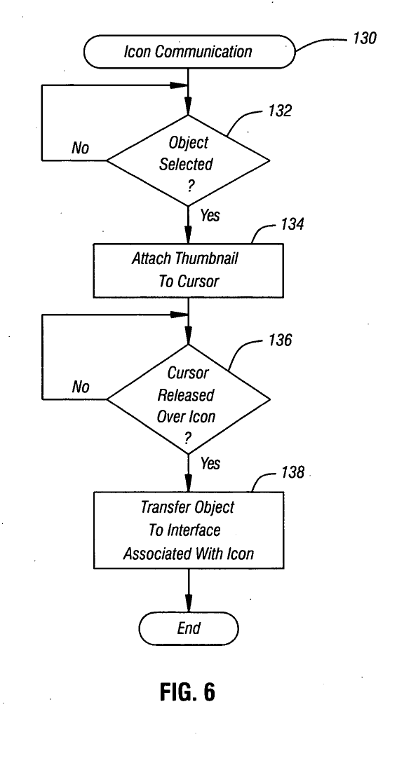

Referring to FIG. 6, the software 130 for implementing an icon-based communication system, in accordance with one embodiment of the invention, begins by determining whether an object has been selected as indicated in diamond 132. When an object has been selected, a thumbnail depiction of the object is attached to a cursor as indicated in block 134. The object, in thumbnail form, then moves wherever the cursor is moved.

A check at diamond 136 determines whether the cursor has been released over another user's icon in the communications interface 68. If so, the object is automatically transferred to a second user's user interface 10 associated with that icon, as indicated in block 138. A thumbnail depiction of the image then shows up in the second user's communication interface 68 when the second user brings the second user's interface 10 into focus. The second user can then either leave the object in the communications interface 68 or drag-and-drop it to the window 58 or to any of the storage areas such as the interface component 16 titled “image gallery”. Alternatively, the second user can drag-and-drop the object to an icon associated with another user. Thus, a very intuitive, easy to understand technique is provided for facilitating communications between users and applications.

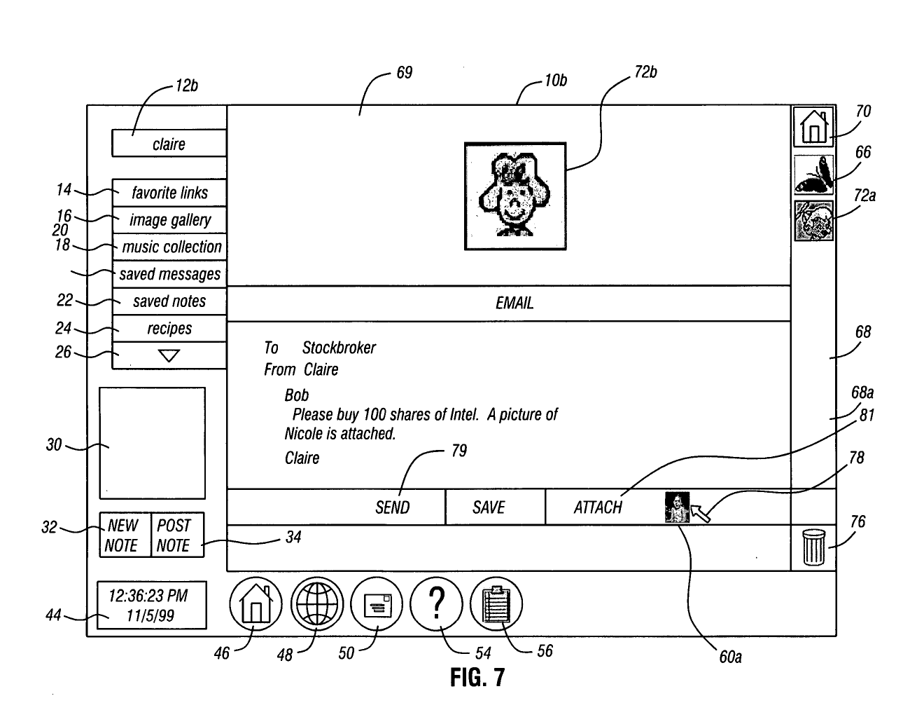

Referring to FIG. 7, an interface lob for the user Claire, indicated by the interface component 12b, is illustrated. In this case, Claire's icon 72b is displayed within the window 58. Claire has selected the function key 50 to prepare an e-mail and therefore, an e-mail graphical user interface is displayed in the workspace 69 that provides the information to fill in the blanks to send an e-mail. In this case, Claire is implementing the request contained in the note 65 she received from Richard to buy 100 shares of Intel stock. To do so, Claire simply fills in the appropriate information in the e-mail and clicks the send button 79 to send the e-mail.

If desired, Claire can attach any of the objects currently located in the communications interface 68. Thus, Claire can send the digital image 75 of her child Nicole as an attachment to the e-mail by simply dragging-and-dropping the thumbnail 60a into the e-mail attach interface 81 (for example from the communications interface 68).

In this case, the communications interface 68 enables communications between different applications operating at different times within the window 58. This enables communications between users and applications without needing a plurality of windows that may unduly complicate the operation of the processor-based system for some users.

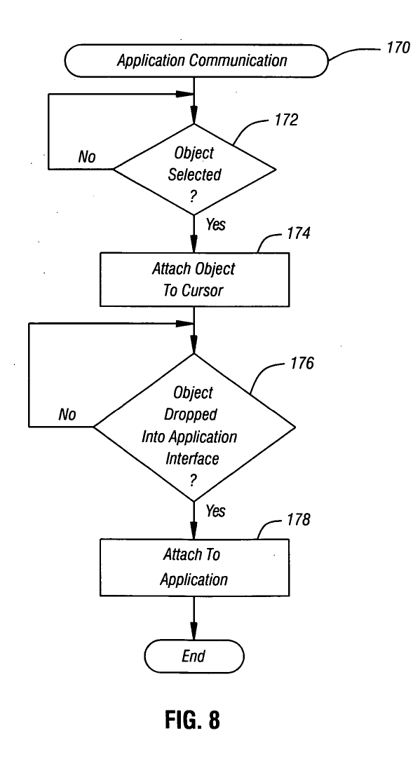

Referring to FIG. 8, the application communication software 170, in accordance with one embodiment of the present invention, begins by determining whether an object in the communications interface 68 has been selected as indicated in diamond 172. If so, the object is attached to a cursor as indicated in block 174 and moved with the cursor.

A check at diamond 176 determines whether the object has been dropped into an application interface in the workspace 69. If so, the object is automatically attached to or otherwise incorporated into the corresponding application (block 178). Thus, in the case of an e-mail, the object is automatically incorporated as an e-mail attachment. In the case of a notepad application, the object may simply be incorporated into the body of the corresponding note.

In one embodiment of the present invention, the object stored in the communications interface 68 do not persist when transferred by dragging-and-dropping them to another area. Thus, when an object is clicked on and dragged out of the interface 68, it disappears from the interface 68 and is no longer available there.

In contrast, the object may be persistently stored by placing it in one of the storage locations represented by the interface components 14 through 24. When an object is stored in one of the interface components 14 through 24, it may be dragged-and-dropped from the interface component 14 through 24 and the original object still persists at its original stored location. That is, when an object in an interface component 14 through 24 is mouse clicked on, a copy attaches to the cursor and moves with the cursor to a new location. Meanwhile, the original persists in the storage represented by the interface component 14 through 24. As a result, the user can selectively cause objects to disappear when transferred or to maintain them persistently by storing them either in the communications interface 68 or in one of the storage locations represented by the interface components 14 through 24.

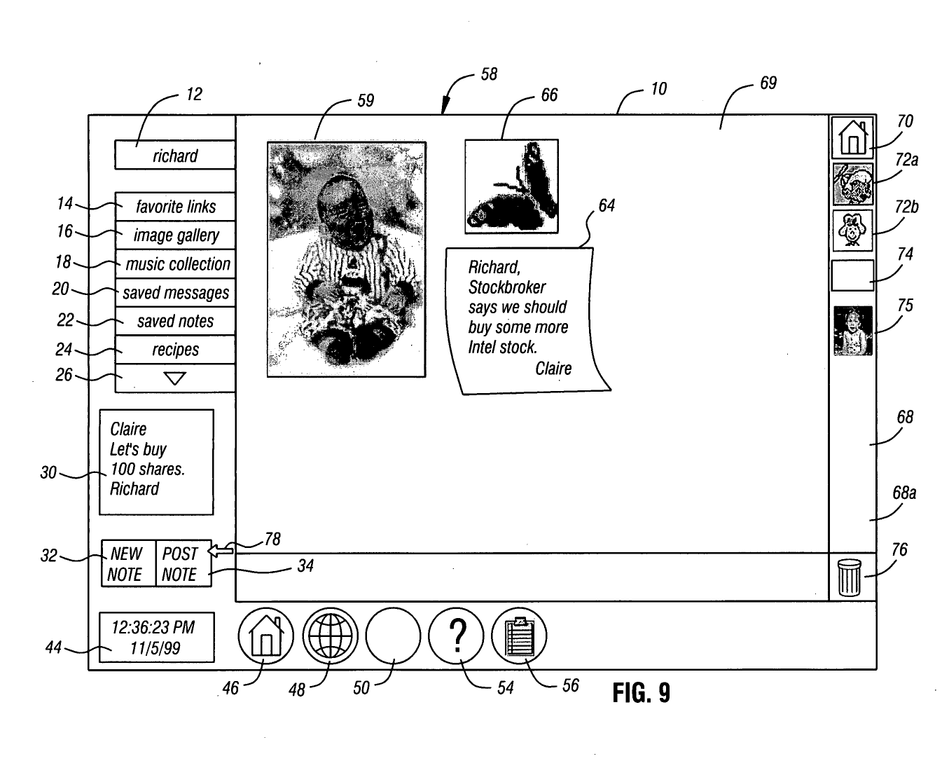

Using the text entry block 30, a user (Richard, icon 66) may prepare a sticky note directed to Claire (icon 72b) asking Claire to buy one hundred shares of stock, as shown in FIG. 9. This may be in response to the sticky note 64 where Claire tells Richard that the stock broker said that they should buy more Intel stock. When the user selects the post note button 34, a representation of a note is automatically transferred into the user's window 58 as shown in FIG. 10 at 65. From there, the user can transfer the note 65 to Claire by dragging-and-dropping the sticky note 65 to the icon 72b associated with Claire. Alternatively, the note may be transferred to the communications interface 68 iconless region 68a for subsequent transfer to another user's interface 10 or another application that may be subsequently displayed in the workspace 69.

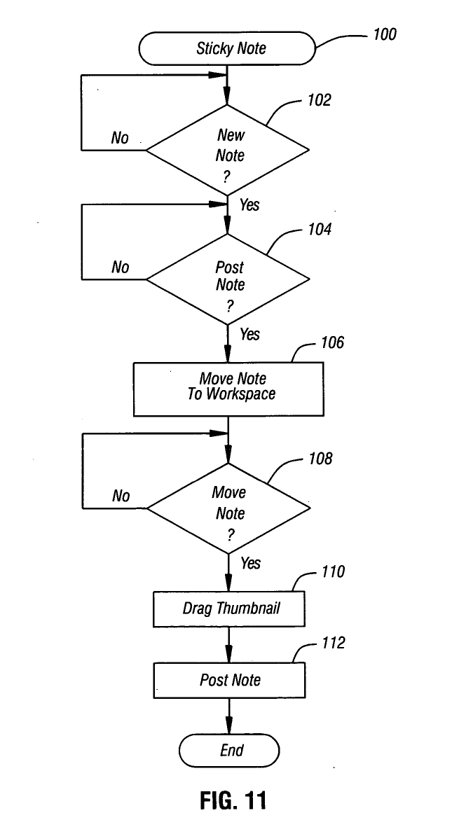

The sticky note software 100, shown in FIG. 11, in accordance with one embodiment of the invention, begins by determining when a new note has been selected for generation as indicated in diamond 102. In one embodiment, the software 100 is advised of a new note when the user operates the button 32. When the user has completed the entry of data into the space 30, the user selects the post note button 34 and the software determines that the post note button 34 has been selected as indicated in diamond 104.

The software 100 then automatically moves the completed note into the workspace 69 and gives it the appearance of sticky note in one embodiment, as indicated in block 106. A check at diamond 108 determines whether the user now wishes to transfer the note to the communications interface 68. If so, the note 65 is converted into a thumbnail depiction and is attached to the cursor 78 so that the user can physically drag the note to the desired destination, as indicated in block 110. Thereafter, the note 65 may be transferred to the communication interface 68. For example, the note 65 may be dragged-and-dropped to a particular icon, such as icon 72b, as indicated in block 112.

Thus, the user gets a clear depiction of what is happening with respect to a selected object because, when the user mouse clicks on the object such as the note 65, the object 65 is immediately reduced to a thumbnail depiction and is attached to the user's cursor 78. Then, when the user moves the cursor to the desired location, the thumbnail depiction accompanies the cursor until the cursor overlies the desired destination and the user releases the mouse button.

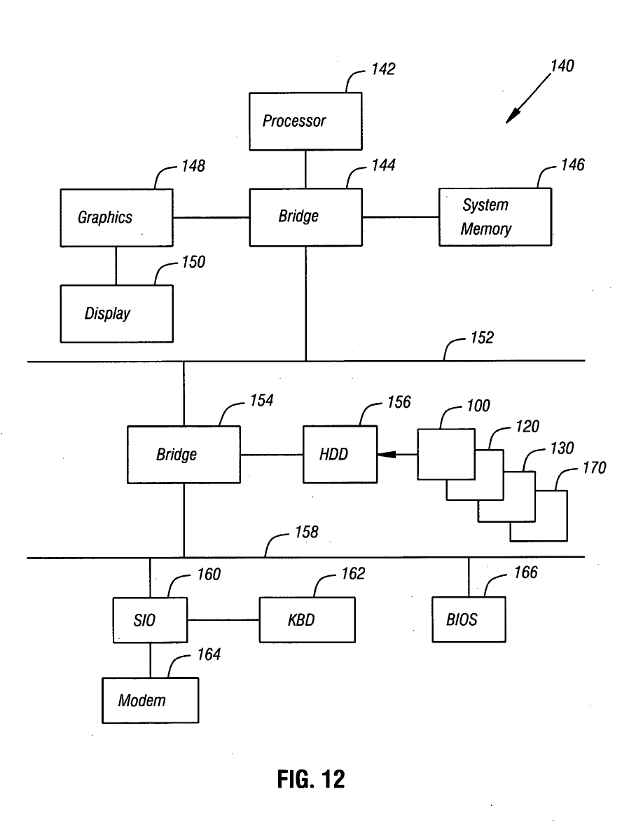

Referring next to FIG. 12, a processor-based system 140 may include a processor 142 coupled to a bridge 144. The bridge 144 may be coupled between a graphics chip 148 and a system memory 146. The graphics chip 148 may be coupled to a display 150 on which an interface 10 may be displayed. The bridge 144 is also coupled to a bus 152 that in turn couples a second bridge 154. The bridge 154 may support a hard disk drive 156 or other storage device. The software 100, 120, 130 and 170 may be stored on the hard disk drive 156.

The bridge 154 is coupled to a second bus 158 which in turn couples to a serial input/output (SIO) device 160. The device 160 may be coupled to a keyboard 162 and a modem 164 for implementing Internet communications. A basic input/output system (BIOS) storage 166 may also be provided on the bus 158. A variety of other hardware implementations may be used.

While a local system is described in which a plurality of users share a single processor-based system, the present invention is likewise applicable to a distributed or networked system wherein users link to the network through separate client processor-based systems. In such case, the software may be resident both on the clients and a server. As still another alternative, instead of using a local area network, the users may be coupled through the Internet via a server and clients that accomplish the features described previously.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A graphical user interface comprising:
a communications interface in association with a window;
a controller to persistently display said communications interface in association with said window and to enable an object to be transferred to different destinations by dragging-and-dropping said object to different locations within said communications interface;
an icon representing a potential object recipient;
a user interface having the appearance of a sticky note such that the user can provide notes on said sticky note; and
said user interface being transferable to said recipient by dragging-and-dropping said note to said icon.

2. The graphical user interface of claim 1 including a plurality of icons representing a plurality of potential recipients.

3. A method comprising:
persistently displaying a communications interface and association with a window;
enabling an object to be transferred to different destinations by dragging-and-dropping said object to different locations within said communications interface;
displaying a communications interface in association with a window, said interface including an icon representing a potential object recipient; and
enabling a user interface in the form of a sticky note to be annotated in order to pass a note to an intended recipient.

4. The method of claim 3 including providing an icon for each of a plurality of users and enabling communications through said communications interface between said users.

5. The method of claim 4 including providing a home interface for said users and enabling communications between said users and said home interface using said communications interface.

6. The method of claim 5 including providing access on a password protected basis to said interfaces associated with said users.

7. The method of claim 3 further including producing a thumbnail depiction of an object when said object is mouse clicked on.

8. The method of claim 7 including attaching a depiction of said object to a cursor so that said depiction moves as said cursor moves.

9. The method of claim 3 including providing a first interface where objects are persistently stored after being transferred from the first interface and a second interface where objects are automatically discarded after being transferred from the second interface.

10. An article comprising a computer storage medium storing instructions that, if executed, enable a processor-based system to:
persistently display a communications interface in association with a window;
enable an object to be transferred to different destinations by dragging-and-dropping said object in different locations in said communications interface;
display a communications interface in association with a window, said interface including an icon representing a potential object recipient; and
enable a user to prepare a note on a user interface having the appearance of a sticky note.

11. The article of claim 10 further storing instructions that enable the processor-based system to enable said object to be transferred to a destination represented by an icon in said communications interface.

12. The article of claim 10 further storing instructions that enable the processor-based system to enable said object to be transferred between users.

13. The article of claim 10 further storing instructions that enable the processor-based system to enable an object to be transferred between application programs.

14. The article of claim 10 further storing instructions that enable the processor-based system to produce a thumbnail depiction of an object when said object is mouse clicked on.

15. The article of claim 14 further storing instructions that enable the processor-based system to attach said object to a cursor so that said object moves as the cursor moves.

16. The article of claim 10 further storing instructions that enable the processor-based system to provide an interface for each of a plurality of users to enable communications through said communication interface between said users.

17. The article of claim 16 further storing instructions that enable the processor-based system to provide a home interface for said users that enables communications between said users and said home interface using said communications interface.

18. A system comprising:
a processor; and
a storage coupled to said processor, to store storing instructions that enable the processor to persistently display a communications interface in association with a window, enable an object to be transferred to different locations by dragging-and-dropping said object in different location within said communications interface, enable a user to provide a user interface having the appearance of a sticky note and transfer said note to a recipient by dragging-and-dropping said note to an icon.

19. The system of claim 18 including a display and a mouse coupled to said processor.

20. The system of claim 19 wherein the storage stores instructions that enable the processor to provide an interface for each of a plurality of users to enable communication through said communication interface between users.

21. The system of claim 20 wherein said storage stores instructions that enable the processor to facilitate communications between users of the same system.

22. The system of claim 19 wherein said storage stores instructions that enable the processor to provide a home interface for said users and enables communications between said users and said home interface using said communications interface.

23. The system of claim 18 wherein said storage stores instructions that enable the processor to automatically produce a thumbnail depiction of an object when said object is mouse clicked on.

24. The system of claim 23 wherein said depiction of said object is automatically linked to said cursor so that said depiction moves as the cursor moves.

25. The system of claim 18 wherein said storage stores instructions that enable the processor to provide a first interface where objects are persistently stored after being transferred from the first interface and a second interface where objects are automatically discarded after being transferred from the second interface.
